(19) United States
(12) Patent Application Publication
(10) Pub. No.: US 2006/0067344 A1
(43) Pub. Date: Mar. 30, 2006

(54) Network system, gateway, radio terminal, and recording medium

(75) Inventor: Kiyoshi Sakurai, Ikoma-gun (JP)

Correspondence Address: BAKER & MCKENZIE LLP;PATENT DEPARTMENT, 2001 ROSS AVENUE, SUITE 2300, DALLAS, TX, 75201, US

(73) Assignee: Icom Incorporated, Hirano-ku (JP)

(21) Appl. No.: 11/241,409

(22) Filed: Sep. 30, 2005

(30) Foreign Application Priority Data
Sep. 30, 2004 (JP) 2004-289431

(51) Int. Cl. H04L 12/56

(52) U.S. Cl. 370/401; 370/328

(57) ABSTRACT

In data communication utilizing amateur radio, communication via Internet can be performed.

A radio terminal belonging to an internal network can communicate with a radio terminal belonging to another internal network via the Internet. Each radio terminal has a callsign, and a gateway has a global IP address and a table which associates each radio terminal with the global IP address of a corresponding gateway. When receiving from a radio terminal, information addressed to a radio terminal in another internal network, the gateway sends the received information to the Internet by addressing it to the global IP address of the gateway of the internal network to which the destination radio terminal 33 belongs with reference to the table. When receiving information from the Internet, the gateway sends the received information to a radio terminal specified by the callsign of a receiver.

This application is based on Japanese Patent Application No. 2004-289431 filed on Sep. 30, 2004 and including specification, claims, drawings and summary. The disclosure of the above Japanese Patent Application is incorporated herein by reference in its entirety.

### BACKGROUND OF THE INVENTION

1. Field of the Invention

The present invention relates to a data communication technique utilizing radio communication.

2. Description of the Related Art

A data communication technique utilizing amateur radio is disclosed in Unexamined Japanese Patent Application KOKAI Publication No. 2003-152738.

In the data communication system disclosed in FIG. 1 of Unexamined Japanese Patent Application KOKAI Publication No. 2003-152738, one repeater is connected to the Internet via a router, and the other repeaters are connected to each other via a back bone BB. A plurality of radio terminals are connected to each repeater and PCs are connected to the radio terminals.

Each radio terminal assembles a radio packet frame from a Ethernet packet frame and transmits it in the amateur band, or reassembles a Ethernet packet frame from a radio packet frame received in the amateur band when the callsign of the receiver contained in the received radio packet frame is the callsign of the radio terminal's own.

When each amateur repeater receives a radio packet frame in the amateur band, it determines whether the callsign of the receiver contained in the received radio packet frame corresponds to any of the callsigns that are under its management. If the callsign corresponds to any such callsign, the amateur repeater discards the received radio packet frame or sends back the received radio packet frame in the amateur band. If the callsign does not correspond, the amateur repeater sends the radio packet frame to the back bone BB. Further, when each amateur repeater receives a radio packet frame from the back bone BB, it checks the callsign of the receiver included in the radio header against the callsigns that are under its management. The amateur repeater sends the received radio packet frame in the amateur band if the callsign corresponds to any of the callsigns under its management, and discards the radio packet frame or sends back the radio packet frame to the back bone BB if the callsign does not correspond.

### SUMMARY OF THE INVENTION

In the system disclosed in Unexamined Japanese Patent Application KOKAI Publication No. 2003-152738, it is desired to perform communication via the Internet between radio networks connected to the Internet (radio network hereinafter referred to as internal network; a communication system connected to the Internet via a single router). However, Unexamined Japanese Patent Application KOKAI Publication No. 2003-152738 does not disclose a method that enables such data communication.

To enable communication between internal networks, it is conceivable to simply add internal networks to the system disclosed in Unexamined Japanese Patent Application KOKAI Publication No. 2003-152738. However, in that case, management of local IP addresses (private IP addresses) becomes complicated, which might cause conflicts of the IP addresses.

The present invention was made in view of the above-described circumstances, and an object of the present invention is to enable communication between internal networks via the Internet.

Another object of the present invention is to provide a communication system in which management of local IP addresses is easy.

Yet another object of the present invention is to broaden the range of use of data communication utilizing amateur radio and to make it easier to use data communication utilizing amateur radio.

To achieve the above objects, a network system according to a first aspect of the present invention is a network system in which a plurality of internal networks are connected to each other via Internet, and radio terminals belonging to each internal network can perform communication with radio terminals belonging to another internal network via the Internet, wherein:

each of said internal networks comprises communication networks, a gateway for connecting said communication networks to Internet, and said radio terminals connected to said communication networks;

each of said radio terminals has identification information (for example, a callsign) that is defined unique in all of said internal networks;

said gateway has a global IP address on the Internet, and includes an address managing table which stores each radio terminal belonging to said internal network in association with the global IP address of said gateway of said internal network to which said radio terminal belongs;

said radio terminals perform communication via said communication network by specifying each other by said identification information;

when said gateway receives information in which identification information of a radio terminal in another internal network is designated as a destination address from a radio terminal via said communication network, it refers to the address managing table to find the global IP address assigned to said gateway of said internal network to which said radio terminal having said destination address belongs, and sends the received information to the Internet to reach the found global IP address; and

when said gateway receives information in which the global IP address of said gateway itself is designated as a destination address from the Internet, it sends the received information via said communication network to a radio terminal which is specified by identification information included in the received information.

For example, when said gateway receives information in which identification information of a radio terminal in another internal network is designated as a destination address from a radio terminal via said communication network, it encapsulates the received information, affixes to the encapsulated information, a header including the global IP address assigned to the gateway of the internal network to which said radio terminal having the destination address belongs to the encapsulated information, and sends the information to the Internet, and when said gateway receives information in which the global IP address of said gateway itself is designated as a destination address, it removes a header affixed to the received information to reproduce encapsulated information, and sends the reproduced information to said communication network.

For example, each radio terminal has an assigned callsign which serves as the identification information, said communication network comprises a repeater which has an assigned callsign and performs radio communication with a predetermined radio terminal by using the callsign, and a network for connecting a plurality of repeaters to said gateway, said radio terminal sends or receives information containing a radio header including the callsigns of a repeater and radio terminal to which the information is addressed, and the callsigns of a repeater and radio terminal from which the information is sent, and said repeater sends or receives information containing a header to and from a repeater which is included in the radio header as a repeater to which the information is addressed or as a repeater from which the information is sent.

For example, each radio terminal comprise data processing devices which each have an assigned local IP address, said radio terminal sends data containing a local IP address of a sender of the data and a local IP address of a receiver of the data, by affixing the radio header to the data, and said radio terminal receives data to which the radio header is affixed, removes the radio header, and specifies a data processing device from the local IP address of the receiver contained in the received data, and provides the received data to the specified data processing device.

For example, a gateway to be newly added in an internal network requires the address managing table from an existing gateway, extracts identification information based on the received address managing table, updates the address managing table based on the extracted identification information, and sends the updated address managing table to all the other gateways. Each gateway sends its own address managing table in response to a request for the address managing table from another gateway, and changes its own existing address managing table to an updated address managing table when it receives the updated address managing table from another gateway.

A gateway according to a second aspect of the present invention is a gateway for connecting an internal network to Internet, in a network system in which a plurality of internal networks are connected to each other via the Internet, and radio terminals belonging to each internal network perform communication with radio terminals in another internal network via the Internet, wherein:

said gateway has a global IP address on the Internet, and includes an address managing table which stores each radio terminal belonging to said internal network in association with the global IP address of said gateway of said internal network to which said radio terminal belongs, and

said gateway comprises:
external sending means for referring to the address managing table when receiving information in which identification information of a radio terminal in an internal network independent from said gateway is designated as a destination address from a radio terminal via a communication network, finding the global IP address assigned to said gateway of said internal network to which said radio terminal specified by the identification information belongs, and sending the received information to the Internet by addressing the received information to the found global IP address; and
internal sending means for, when receiving information addressed to said gateway itself from the Internet, sending the received information to a radio terminal which is specified by identification information included in the received information via said communication network.

For example, the identification information is a callsign. In this case, for example, when said external sending means receives data to which a radio header including a companion station callsign designating a radio terminal in another internal network, a destination repeater callsign, a departure repeater callsign, and a own station callsign designating a radio terminal from which the data is sent is affixed, said external sending means encapsulates the received data, affixes to the encapsulated data a radio header including the global IP address of a gateway to which the data is sent and the global IP address of said gateway itself, and sends the data to the Internet. When said internal sending means receives information in which the global IP address of said gateway itself is designated as a destination address from the Internet, it removes a radio header from the received information to reproduce data to which a radio header is affixed, and sends the reproduced data to said communication network.

Further, in the case where the identification information is a callsign, when said external sending means receives data to which a radio header including a destination repeater callsign designating said gateway itself, a departure repeater callsign, a companion station callsign, and a own station callsign is affixed, said external sending means rewrites the destination repeater callsign included in the radio header into a callsign of a repeater with which a radio terminal specified by the companion station callsign included in the radio header performs radio communication, and rewrites the departure repeater callsign included in the radio header into a callsign of a gateway to which the received data is to be sent, and encapsulates the rewritten radio header and the data, affixes a radio header including a global IP address to which the data is to be sent and the global IP address of said gateway itself to the encapsulated data, and sends it to the Internet.

For example, the address managing table further stores information that associates the callsign of said radio terminal, information for specifying data processing devices which are connected to said radio terminal, and local IP addresses of said data processing devices with one another. In this case, when said gateway receives an inquiry request containing the callsign of a radio terminal and the information for specifying a data processing device connected to said radio terminal, said gateway finds the local IP address assigned to said data processing device from the address managing table and sends the local IP address to the request sender.

A radio terminal according to a third aspect of the present invention is a radio terminal used in a network system in which a plurality of internal networks each comprise radio terminals, a repeater for performing radio communication with said radio terminals, and a gateway connected to said repeater via a communication cable, each of said internal networks is connected to Internet via said gateway, and each of said radio terminals performs communication with said radio terminal belonging to another internal network via said repeater, said gateway, and the Internet, said radio terminal comprising:

radio communication means;

data communication means for sending and receiving data to and from data processing devices;

input means for receiving an input of identification information of a radio terminal to which data is to be sent; and

control means for affixing to data to be sent that is received from a data processing device by said data communication means, a radio header including a callsign of a repeater to which the data is to be sent, a callsign of a repeater from which the data is to be sent, a callsign of a radio terminal to which the data is to be sent, and a callsign of said radio terminal itself from which the data is to be sent based on the information input from said input means, and sending the data via said radio communication means to said repeater from which the data is to be sent, while when receiving data to which a radio header including a callsign of said radio terminal itself as a destination address is affixed from said repeater, removing the radio header from the received data, identifying a data processing device from a destination address included in the received data, and providing the received data to said identified data processing device,

wherein when data is to be sent to a radio terminal in another internal network, said control means designates a callsign of said gateway in said internal network to which said radio terminal itself belongs as the callsign of a repeater to which the data is to be sent, and designates a callsign of said radio terminal to which the data is finally addressed as the callsign of a radio terminal to which the data is to be sent.

A program for controlling a computer having a radio communication function to act as a network system, a gateway server, a radio terminal, and the like having the above-described configuration may be distributed by being recorded on a recording medium or may be distributed via a network by being embedded on a carrier wave. This computer program is recorded on a recording medium of a computer and installed in the computer.

### BRIEF DESCRIPTION OF THE DRAWINGS

These objects and other objects and advantages of the present invention will become more apparent upon reading of the following detailed description and the accompanying drawings in which:

FIG. 1 is a block diagram of a network system according to an embodiment of the present invention;

FIG. 2 is a diagram showing an example of assignment of callsigns;

FIG. 3 is a diagram showing a configuration of a local repeater and a radio terminal;

FIG. 4 is a diagram showing a configuration of a gateway server;

FIG. 5 is a diagram showing an example of a configuration of an IP managing server;

FIG. 6 is a diagram showing an example of an IP managing table;

FIG. 7 is a diagram showing an example of a format of a packet sent in the network system of FIG. 1;

FIG. 8 is a flowchart showing a process for obtaining an IP address;

FIG. 9 is a flowchart showing a communication process using an IP address;

FIG. 10 is a flowchart showing a packet sending process in the IP managing server;

FIGS. 11 are diagrams showing structures of radio packets, where FIG. 11A shows an example of structure of a packet for IP address inquiry and FIG. 11B shows an example of structure of a packet for reply to the inquiry;

FIGS. 12 are diagrams showing structures of packets to be transmitted for communication within an intranet via the Internet, where FIG. 12A shows an example of structure of a radio packet, FIG. 12B shows an example of structure of a radio packet which is rewritten in the gateway server, and FIG. 12C shows an example of structure of a packet to be output to the Internet;

FIG. 13 is a diagram showing a structure of a radio packet for a case where communication is performed within one zone network;

FIG. 14 is a diagram showing a structure of a radio packet for a case where communication is performed with an arbitrary device on the Internet;

FIG. 15 is a diagram showing a modified example of a manner of determining whether or not to transform a radio packet into a VPN format, the diagram being a modified example of the flowchart of FIG. 9;

FIG. 16 is a diagram shown the whole of a process for updating the IP managing table;

FIG. 17 is a flowchart showing a process for expanding and setting an IP address range;

FIG. 18 is a flowchart showing a process for making an inquiry about the IP managing table and sending the IP managing table; and

FIG. 19 is a flowchart showing a process for receiving and storing a updated IP managing table.

### DETAILED DESCRIPTION OF THE PREFERRED EMBODIMENT

A network system according to one embodiment of the present invention will now be explained with reference to the drawings.

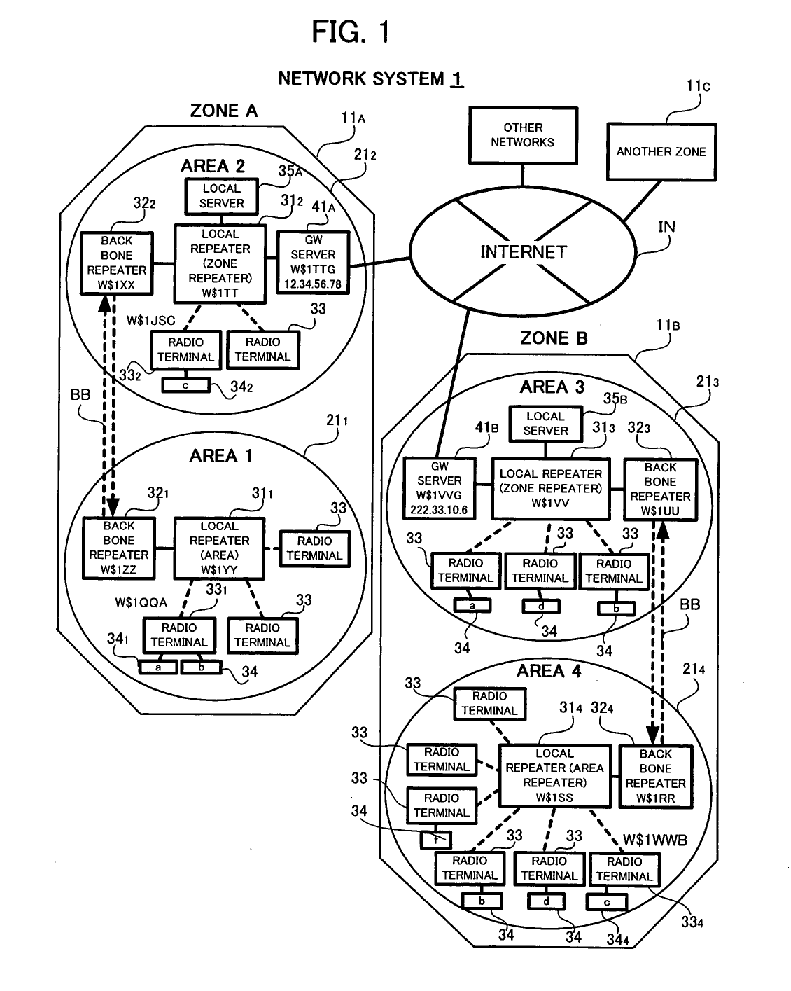

The network system 1 according to the present embodiment has a configuration in which a plurality of zone networks (internal networks) 11 (11_{A}, 11_{B}, . . . ) are connected to Internet IN, as shown in FIG. 1. The plurality of zone networks 11 build up a kind of intranet.

Each zone network 11 comprises one or a plurality of area networks 21 (21₁, 21₂, . . . ).

Each area network 21 comprises a local repeater 31 (31₁, 31₂, 31₃, 31₄, . . . ), a back bone repeater 32 (32₁, 32₂, 32₃, 32₄, . . . ), and a plurality of radio terminals (devices) 33 connected to the local repeater 31.

The local repeater 31 (31₂, 31₃, . . . ) of any one of the area networks 21 (21₁, 21₂, . . . ) in each zone network 11 (11_{A}, 11_{B}, . . . ) is connected to the Internet IN via a gateway and IP server (GW server) 41 (41_{A}, 41_{B}, . . . ).

The back bone repeaters 32 (32₁ and 32₂, 32₃ and 32₄, . . . ) in the area networks 21 belonging to the same zone network 11 are connected to each other via a back bone BB.

Each radio terminal 33 is connected to the local repeater 31 in the same area network 21 as it belongs to, in the amateur band. Each radio terminal 33 is constituted by a digital radio communication terminal which uses an amateur radio band.

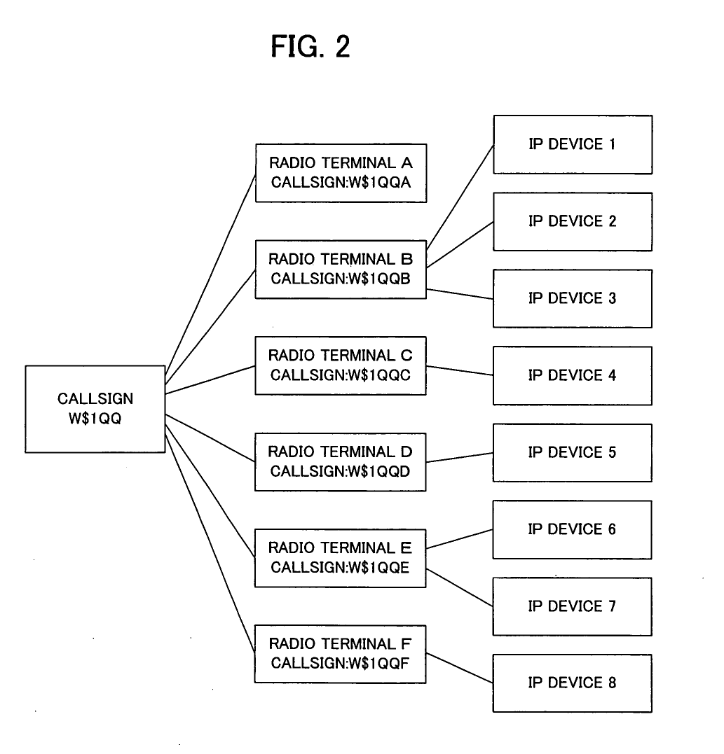

An arbitrary callsign (identification symbol of an amateur radio station assigned by a local telecommunications bureau) is assigned to each radio terminal 33. As shown in FIG. 2, six radio terminals A to F at the maximum can be assigned per callsign (W$1QQ in FIG. 2), and the callsign of each radio terminal is represented as, for example, W$1QQA, the last letter of which indicates the terminal identification symbol (any of A to F). Accordingly, each radio terminal possesses an identification symbol that is unique over the plurality of zone networks.

One or a plurality of IP devices 34 are connected to each radio terminal 33 as needed. A local (private) IP address is assigned to each IP device 34. Eight local IP addresses at the maximum can be assigned per callsign. Therefore, eight IP devices at the maximum can be connected to one radio terminal 33.

For example, a radio terminal A which is prepared for voice communication purposes only is used singularly, whereas the IP devices 34 are connected to radio terminals B to F that are for data communication purposes. As the IP devices 34, arbitrary data processing devices such as a personal computer (indicated by a symbol “a” in FIG. 1), an IP camera (indicated by a symbol “b” in FIG. 1), etc. can be used.

The radio terminal 33 performs packet communication with the local repeater 31 in the same area network through amateur radio communication using a callsign, and exchanges data with the IP devices 34.

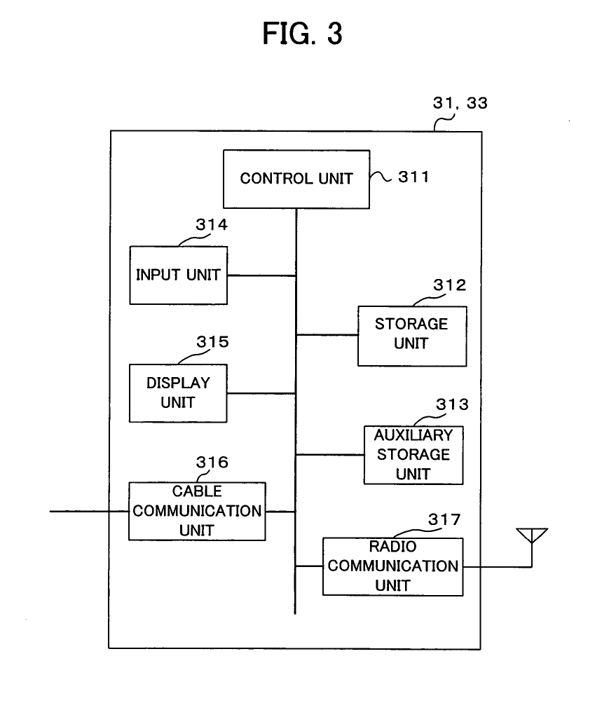

In order to realize these functions, the radio terminal 33 comprises a control unit 311, a storage unit 312, an auxiliary storage unit 313, an input unit 314, a display unit 315, a cable communication unit 316, and a radio communication unit 317, as shown in FIG. 3.

The control unit 311 is constituted by a CPU (Central Processing Unit) or the like, and executes a program read into the storage unit 312 to perform communication control to be described later.

The storage unit 312 is constituted by a RAM (Random Access Memory), a ROM (Read Only Memory), etc., and stores operation programs and data for the control unit 311.

The auxiliary storage unit 313 is constituted by a hard disk device or the like, and stores information on the zone network 11 such as a list indicating the callsigns of the radio terminals 33, local repeater 31, and GW server 41 and connection relations between these, the callsign of the radio terminal 33 itself, and the IP address (local IP address) of each IP device 34 connected to the radio terminal 33 itself, and also operation programs, etc. for the control unit 311.

The input unit 314 includes a keyboard, a mouse, etc., and receives input of various instructions and setting information such as, for example, the callsign of a data receiver.

The display unit 315 displays various information.

The cable communication unit 316 performs communication with the IP device 34 via a cable such as, for example, a USB (Universal Serial Bus) or Ethernet (Registered Trademark) under the control of the control unit 311.

The radio communication unit 317 performs radio communication with the local repeater 31 in the amateur band under the control of the control unit 311.

The radio terminal 33 may further comprise an audio processing circuit for audio communication, though not illustrated in FIG. 3.

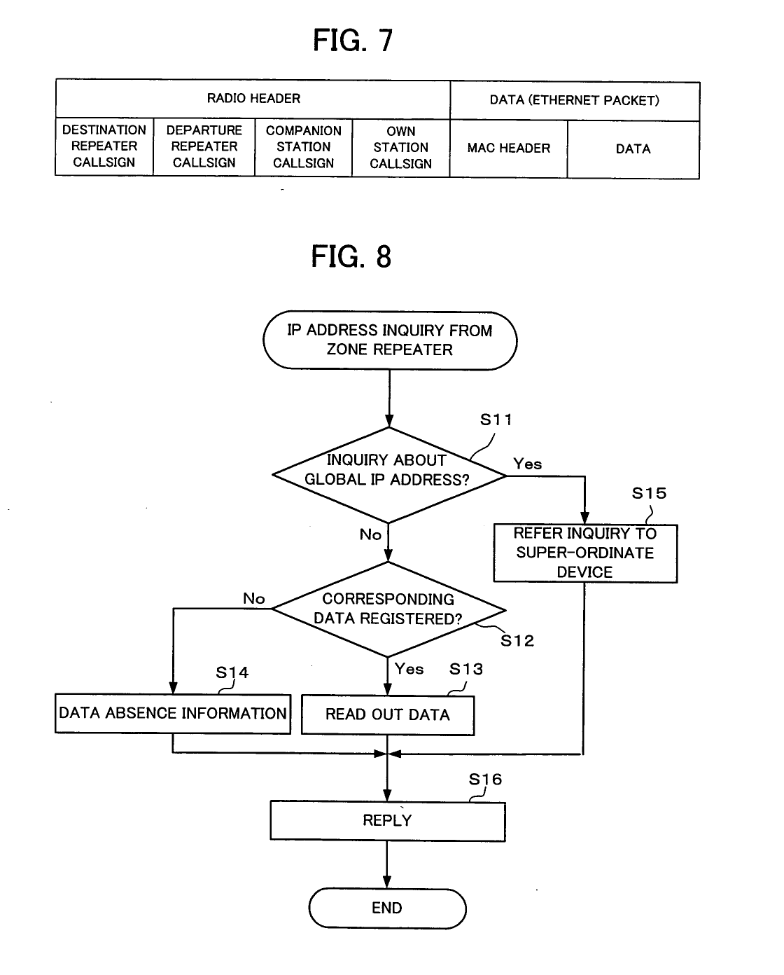

With the above-described configuration, mainly the control unit 311 of the radio terminal 33 performs radio communication with the local repeater 31 via the radio communication unit 317, and performs data communication with the IP device 34 via the cable communication unit 316. The radio terminal 33 affixes a radio header, which is to be described later with reference to FIG. 7, to data (a packet for LAN (Local Area Network) such as, for example Ethernet (Registered Trademark); hereinafter referred to as LAN packet) provided from the IP device 34, and sends the LAN packet to the local repeater 31. The radio terminal 33 receives data to which a radio header including the callsign of the radio terminal 33 itself as the data receiver is affixed from the local repeater 31, removes the radio header from the received data, identifies an IP device 34 from a local IP address included in the data, and supplies the data to the identified IP device 34.

As shown in FIG. 7, a radio header includes information such as the callsign of the repeater of the data destination side (to which data is sent), the callsign of the repeater of the data departure side (from which data is sent), the callsign of a companion station (the callsign of a radio terminal to which data is sent), the callsign of a own station (the callsign of the radio terminal itself from which data is sent), etc. When, for example, a user designates the callsign of the radio terminal 33 of the data companion side from the input unit 314, the control unit 311 generates information such as the callsign of the repeater of the data destination side (the callsign of the local repeater 31 in the same area network 21 as the designated radio terminal 33 belongs to), the callsign of the repeater of the data departure side (the callsign of the local repeater 31 with which the radio terminal 33 itself directly communicates), the callsign of the radio terminal 33 itself, etc. based on the information stored in the auxiliary storage unit 313, thereby assisting the user in inputting information.

When data is to be sent to a radio terminal 33 in a different zone network 11, the control unit 311 designates the callsign of the GW server 41 in the zone network 11 it belongs to as the callsign of the repeater of the data destination side, and designates the callsign of the radio terminal 33 to which the data is to be sent as the callsign of the companion station.

Next, the local repeater 31 shown in FIG. 1 will be explained in detail.

The local repeater 31 performs packet communication with the radio terminals 33 in the same area network 21 as it belongs to in the amateur band communication using callsigns. Further, the local repeater 31 performs communication with the back bone repeater 32 by radio or by cable in order to communicate with other area networks 21 in the same zone network 11.

Further, one local repeater (31₂ and 31₃) of the local repeaters 31 belonging to each zone network 11 functions as a zone repeater for connecting the zone network 11 to the Internet IN. The zone repeater 31 is connected to the Internet IN via the GW server 41, sends a packet which is addressed to somewhere outside the zone network 11 to the Internet IN via the GW server 41, and receives a packet addressed to the zone network 11 from the Internet IN via the GW server 41. And if the received packet is addressed to the area network 21 to which the zone repeater 31 belongs to, the zone repeater 31 sends the packet by radio, while if the packet is addressed to another area network 21 it sends the packet to the back bone repeater 32.

In order to realize the above-described functions, the local repeater 31 comprises, as the basic configuration, the control unit 311, the storage unit 312, the auxiliary storage unit 313, the input unit 314, the display unit 315, the cable communication unit 316, and the radio communication unit 317 shown in FIG. 3, likewise the radio terminal 33.

The control unit 311 is constituted by a CPU (Central Processing Unit) or the like, and executes a program read into the storage unit 312 to perform communication control to be described later.

The storage unit 312 is constituted by a RAM, a ROM, etc., and stores operation programs and data for the control unit 311.

The auxiliary storage unit 313 is constituted by a hard disk device or the like, and stores the callsigns of each radio terminal 33 and back bone repeater 32, and operation programs for the control unit 311.

The input unit 314 includes a keyboard, a mouse, etc., and receives input of various instructions and setting information.

The display unit 315 displays various information.

The cable communication unit 316 performs communication with another device through a cable such as, for example a LAN including Ethernet (Registered Trademark) under the control of the control unit 311.

The radio communication unit 317 performs communication with the radio terminal 33 in the amateur band under the control of the control unit 311.

The local repeater 31 and the radio terminal 33 have the same basic configuration, but their power, performance, etc. are properly set depending on the device characteristics.

The back bone repeater 32 is connected to the local repeater 31, and performs two-way communication with the back bone repeater 32 in another area network 21 in the same zone network 11 to perform data exchange.

After all, the local repeater 31 and the back bone repeater 32 constitute a kind of local communication network, and the radio terminal 33 is connected to this communication network via the local repeater 31 and the GW server 41 is connected to this communication network via a LAN (for example, Ethernet (Registered Trademark)).

A local server 35 is a server used in common by the devices in the same zone network 11 for various purposes.

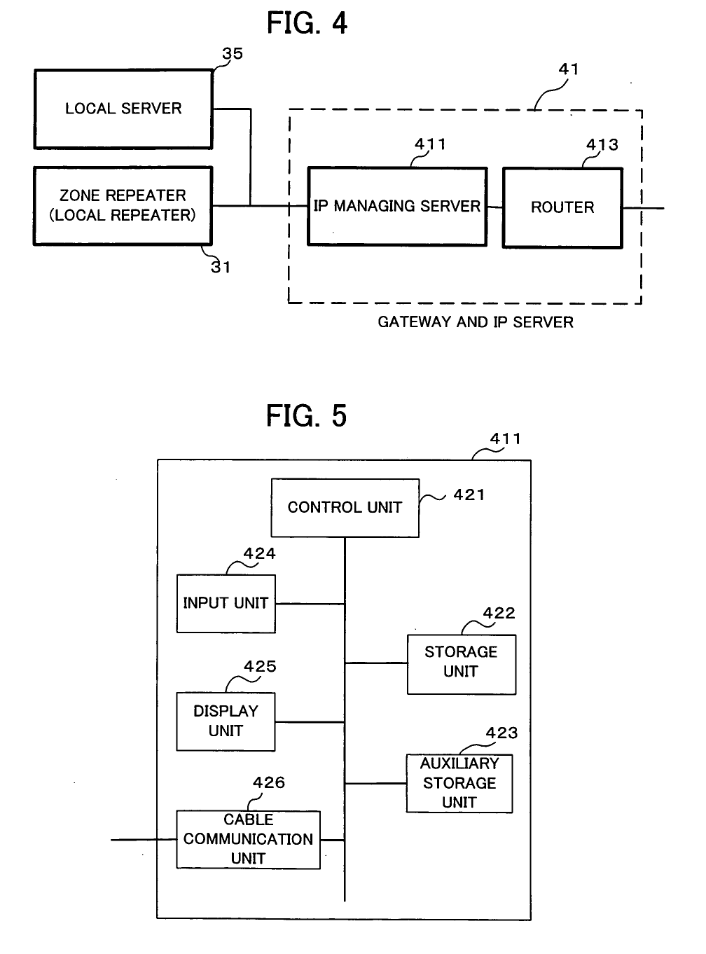

The GW server 41 (41_{A}, 41_{B}) shown in FIG. 1 is for connecting the Internet IN and each zone network 11, and is constituted by an IP managing server 411 and a router 413 as shown in FIG. 4. A callsign is also assigned to the IP managing server 411. The callsign to be assigned to the IP managing server 411 is arbitrary, and according to the present embodiment it is made up of the callsign of the local repeater 31 to which the IP managing server 41 is connected (for example, the callsign of the local repeater 31 being W$1QQ) pulse a character “G” at the tail (to produce W$1QQG, for example).

The IP managing server 411 performs various managing and controlling operations for connecting the zone network 11 and the Internet IN, and functions as, for example, a DNS (Domain Name System) server. The IP managing server 411 as the DNS server has, for example, a function of managing local IP addresses in the zone network 11 to which the GW server 41 belongs to and a function as a DNS cache server for performing searches for domain names. The IP managing server 411 comprises a control unit 421, a storage unit 422, an auxiliary storage unit 423, an input unit 424, a display unit 425, and a cable communication unit 426, as shown in FIG. 5.

The control unit 421 is constituted by a CPU (Central Processing Unit) or the like, and executes a program read into the storage unit 422 to perform operations as the DNS server and communication control which are to be described later.

The storage unit 422 is constituted by a RAM, a ROM, etc., and stores operation programs and data for the control unit 421.

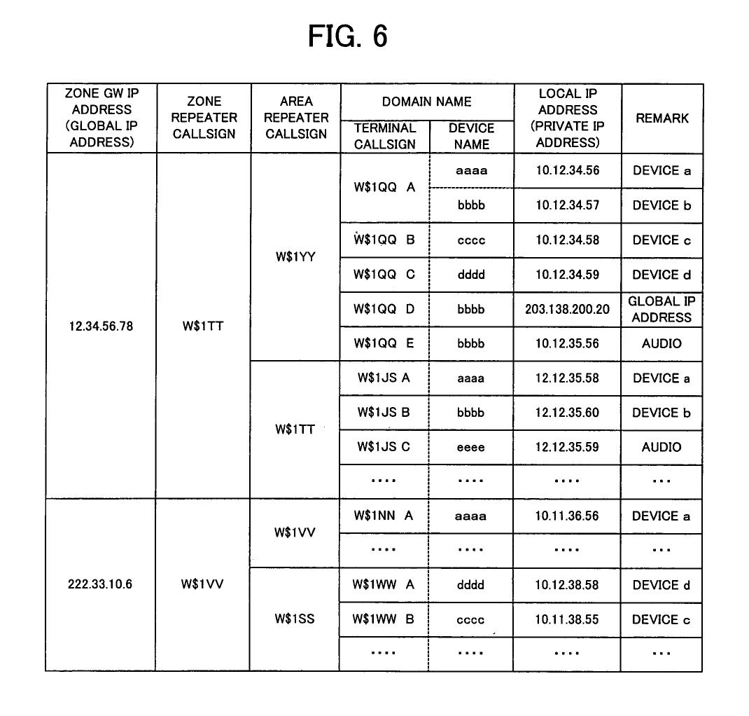

The auxiliary storage unit 423 is constituted by a hard disk device or the like, and stores an IP managing table shown in FIG. 6, etc.

The input unit 424 includes a keyboard, a mouse, etc., and receives input of various instructions and setting information.

The display unit 425 displays various information.

The cable communication unit 426 performs communication with repeaters and routers via a cable such as a LAN including, for example, Ethernet (Registered Trademark) under the control of the control unit 421.

The IP managing table stored in the auxiliary storage unit 423 is common to all the GW servers 41, and as shown in FIG. 6, registers a global IP address assigned to the GW server 41 in the zone network 11 constituting the intranet, the callsign assigned to the zone repeater 31 in the zone network 11, the callsigns of the local repeaters (area repeaters) 31, domain names (including the callsigns and device names of the radio terminals 33 connected to the area repeaters 31), the IP addresses (local IP addresses) of the IP devices 34 connected to the radio terminals 33, and remark information (arbitrary information other than those above) all in association.

The IP managing server 411 refers to the IP managing table and thereby performs processes for answering inquiries from IP devices about local IP addresses of other devices in the intranet, or sending packets to the Internet IN and catching packets from the Internet IN into the zone network 11.

The router 413 constituting the GW server 41 connects the zone network 11 (IP managing server 411) and the Internet IN.

Next, a communication scheme in the network system 1 having the above-described configuration will be explained.

In performing radio transmission, each device assembles a packet having a format shown in FIG. 7, and sends or receives such a packet.

This radio packet is constituted by an ordinary LAN packet which is encapsulated and headed with a radio header.

The radio header includes the callsign of the repeater of the destination side, the callsign of the repeater of the departure side, the callsign of the companion station, and the callsign of the own station. The LAN packet includes MAC (Media Access Control) header, data, etc.

Next, the communication procedures in the network system 1 will be explained.

(1) Inquiry about IP Address

When a user is to perform communication with another IP device 34 by using an arbitrary IP device 34, the user needs to know the IP address of the IP device 34 with which the user is going to communicate with.

In a case where the user has already acquired the local IP address of the IP device 34 of the companion side with which the user is to communicate with, the user uses that local IP address. However, in a case where the user has not yet acquired the local IP address of the IP device 34 of the companion side, the user inquires of the GW server 41 in the zone network 11 to which the user belongs to about the IP address of the IP device 34 of the companion side. The IP address to be inquired may arbitrarily be a global IP address, or a local IP address in the same internal network as the user belongs to.

In this case, in order to inquire the IP address of the IP device 34 of the companion side, the IP device 34 assembles an IP address inquiry packet by designating the domain of the IP device 34 of the companion side. The information for specifying the IP device 34 of the companion side is arbitrary, but the domain name of the IP device 34 of the companion side should be designated in a case where the IP device of the companion side is located in the same zone (internal) network 11.

The radio terminal 33 affixes a radio header to the produced inquiry packet and sends the packet to the local repeater 31 in the same area network 21 as it belongs to. In this case, the radio header includes the callsign of the GW server 41 as the callsign of the repeater of the destination side (in a case where the callsign of the GW server 41 is the callsign of the local repeater 31 plus the character “G”), the callsign of the local repeater 31 in the same area network 21 as the radio terminal 33 itself belongs to as the callsign of the repeater of the departure side, the callsign of the radio terminal 33 of the companion side as the callsign of the companion station, and the callsign of the radio terminal 33 itself as the callsign of the own station.

The inquiry packet is received by the local repeater 31 in the same area network 21 and reaches the GW server 41, via the back bone BB if necessary.

The IP managing server 411 constituting the GW server 41 picks out the LAN packet included in the received packet, and starts the process shown in FIG. 8 if it determines that the LAN packet is an inquiry about a local IP address.

First, the IP managing server 411 determines whether the inquiry is about a global IP address or about a local IP address (step S11).

In a case where determining from the domain name, etc. that the inquiry is about an IP address of an IP device 34 in the same internal network (step S11; No), the IP managing server 411 determines that the inquiry is about a local IP address and refers to the IP managing table.

The IP managing server 411 determines whether corresponding data (domain name) is registered in the IP managing table (step S12), and if registered, reads out the associated local IP address (step S13).

On the contrary, in a case where the required domain name is not registered in the IP managing table, the IP managing server 411 produces information indicative of the absence of data (step S14).

In a case where determining in step S11 that the inquiry is about a global IP address, for example, in a case where the inquiry is about an IP address for an ordinary URL (Uniform Resource Locator) (step S11; Yes), the IP managing server 411 inquires of a super-ordinate device existing on the Internet IN to acquire the global IP address (step S15).

The IP managing server 411 assembles a reply packet including the IP address (either local or global) thusly obtained or including the data absence information, and sends it to the inquiring IP device (step S16).

The inquiring IP device 34 receives the answer packet and acquires the IP address of the IP device of the companion side.

(2) Communication using the IP Address

Next, the IP device 34 assembles a LAN packet by designating the thusly obtained IP address or an IP address obtained before as the address of the companion side and also designating the IP address of the IP device 34 itself as the address of the own side, and sends the packet to the radio terminal 33. Further, the user inputs the callsign of the repeater of the destination side and the callsign of the radio terminal 33 of the companion side to the radio terminal 33. In a case where the communication partner with which the user is to communicate exists outside the zone network 11 to which the radio terminal 33 of the user belongs, the callsign of the GW server 41 in the zone network 11 to which the radio terminal 33 of the user belongs is designated as the callsign of the repeater of the destination side.

The radio terminal 33 assembles a radio header including the callsign of the repeater of the destination side, the callsign of the radio terminal 33 of the companion side, the callsign of the repeater of the departure side, and the callsign of the radio terminal 33 itself and affixes the radio header to the LAN packet which is encapsulated to produce a radio packet as shown in FIG. 7, and sends the radio packet in the amateur band.

The radio packet is received by the local repeater 31 in the area network 21 to which the radio terminal 33 belongs.

The local repeater 31 sends back the received radio packet in the amateur band if the radio header thereof includes, as the callsign of the repeater of the destination side, the callsign of the local repeater 31 itself, or sends the received radio packet to the back bone BB via the back bone repeater 32 if the radio header includes the callsign of another local repeater.

In a case where the final destination of this packet is located in the same zone network 11 as the sender of this packet belongs to, the packet is transferred to the corresponding area repeater 31, sent to the radio terminal 33 by radio, and provided to the intended IP device 34 with the radio header removed.

On the other hand, in a case where the final destination of the packet is located in another zone network 11, the packet reaches the GW server 41 via the zone repeater 31 in accordance with the radio header.

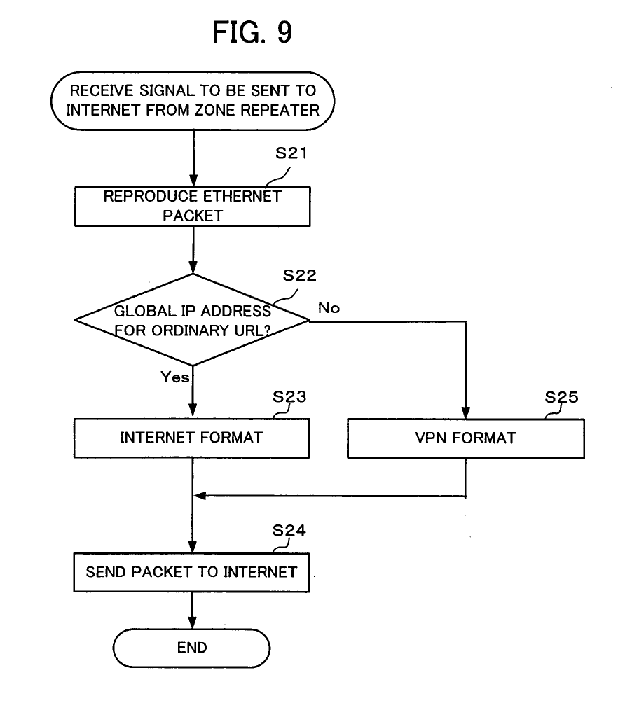

The IP managing server 411 constituting the GW server 41 starts the process shown in FIG. 9, and first picks out the LAN packet (step S21).

The IP managing server 411 determines whether the IP address indicating the destination of the LAN packet is a global IP address for an ordinary URL or not (step S22).

In a case where the IP address is a global IP address for an ordinary URL, the IP managing server 411 formats the packet in an Internet format (step S23), and sends the packet to the Internet IN via the router 413 (step S24). After this, ordinary Internet packet processes will follow.

On the other hand, in a case where the IP address is not a global IP address for ordinary URL, i.e., in a case where the transmission of this packet is within the intranet, the IP managing server 411 assembles a communication packet in a VPN (Virtual Private Network) format (step S25) by encapsulating the received packet (radio header+data) and affixes thereto a radio header in which the global IP address of the GW server 41 in the zone network 11 including the final-destination IP device is designated as the address of the companion side and the global IP address of the IP managing server 411 itself is designated as the address of the own side, and sends the communication packet to the Internet IN via the router 413 (step S24). In encapsulating the received packet, the IP managing server 411 may encode the packet according to a predetermined algorithm.

Incidentally, the control unit 311 rewrites the callsign of the repeater of the destination side included in the radio header into the callsign of the local repeater 31 associated with the radio terminal 33 which is specified by the callsign of the companion station included in the radio header, and rewrites the callsign of the repeater of the departure side into the callsign of the GW server 41 of the zone network 11 of the companion side. This rewriting increases the convenience because the radio terminal 33 of the companion side can easily send a reply by simply interchanging the address of its own with the address of the sender from which it has received the packet.

The communication packet is transmitted through the Internet IN, received by the router 413 of the zone network 11 of the companion side, and transferred to the IP managing server 411.

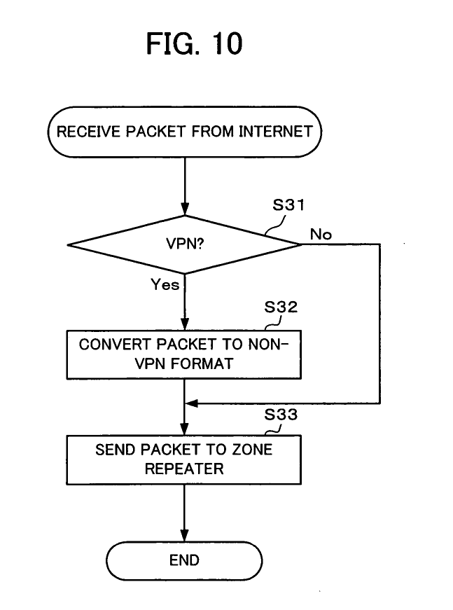

The IP managing server 411 starts the process shown in FIG. 10, and determines whether the packet corresponding to the payload portion is in the VPN format (step S31). If it is in the VPN format, the IP managing server 411 restores it into an un-coded packet (step S32), and sends it to the zone repeater 31 (step S33). This packet is sent from the zone repeater 31 to the intended radio terminal 33 according to the radio header. The radio terminal 33 removes the radio header from the received packet, and processes the packet by itself to output a voice or identifies an IP device 34 from the local IP address to send the data to the identified IP device 34.

In the way described above, packet communication utilizing amateur radio becomes possible.

The above-described operation will be explained by employing a specific example.

(1) First, an operation performed by the radio terminal 33₁ in Area 1 for inquiring the local IP address of a device “aaaa” (34₄) among the IP devices 34 connected to the radio terminal 33₄ in Area 4 will be explained.

In this case, the radio terminal 33₁ inquires of the GW server 41_{A} in the zone network 11_{A} about the local IP address of the IP device 34₄.

The user inputs (a) the callsign W$1TTG of the GW server 41_{A} as the callsign of the repeater of the destination side, (b) the callsign W$1YY of the local repeater 31₁ in Area 1 as the callsign of the repeater of the departure side, (c) the domain name of the companion station (the callsign W$1WWB of the radio terminal 33₄ and the name of the IP device 34₄ as the callsign and information for specifying the IP device connected to the station having that callsign), and (d) the callsign W$1QQA of the radio terminal 33₁ as the callsign of the own station. Other kind of information may be input and the radio terminal 33₁ may obtain the above-listed information by appropriately converting the input information. Finally, the user inputs an instruction for an inquiry about an IP address from the input unit.

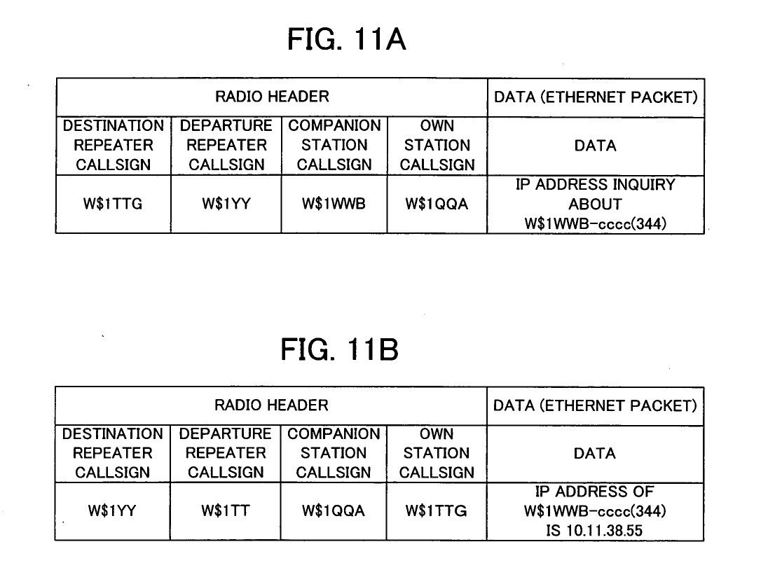

In response to this instruction, the radio terminal 33₁ assembles an IP address inquiry packet as shown in FIG. 11A, containing a radio header which is based on the input information, and sends the inquiry packet to the local repeater 31₁. A radio packet which is assembled in radio terminal comprises data portion which contains the Ethernet packet including the information of IP address of the IP device and radio header which contains the information of callsigns. The data portion which contains the Ethernet packet is generated in the IP device. The radio packet is assembled in the radio terminal by adding the generated radio header to the data portion which contains the Ethernet packet. That is, the radio terminal 33₁ assembles a radio packet containing a radio header including (a) the callsign W$1TTG of the GW server 41_{A} in the same zone A as the callsign of the repeater of the destination side, (b) the callsign W$1YY of the local repeater 31₁ as the callsign of the repeater of the departure side, (c) the callsign W$1WWB of the radio terminal 33₄ in Area 4 as the callsign of the companion station, and (d) the callsign W$1QQA of the radio terminal 33₁ as the callsign of the own station, and also containing data representing that this packet is an inquiry about the IP address of the IP device 34₄, and sends the produced packet to the local repeater 31₁.

The local repeater 31₁ receives the radio packet, and with reference to the callsign of the repeater of the destination side included in the radio header (the six higher-order characters W$1TT), sends the radio packet to the back bone BB via the back bone repeater 32.

The radio packet is transmitted through the back bone BB to reach the zone repeater 31₂ in accordance with the callsign of the repeater of the destination side (the six higher-order characters), and the zone repeater 31₂ passes the radio packet to the GW server 41_{A} in accordance with the callsign W$1TTG of the repeater of the destination side (or the last character “G”).

The GW server 41_{A} (or the IP managing server 411 to be more accurate, but hereinafter both servers will be collectively called GW server to facilitate understanding) picks out a LAN packet from the radio packet and identifies the content of the LAN packet. The GW server 41_{A} refers to the IP managing table in the GW server 41_{A}, and finds the local IP address (10.11.38.55) of an IP device 34₄ having the name “aaaa” among the IP devices 34 connected to the radio terminal 33₄ having the callsign W$1WWB.

The GW server 41_{A} assembles a reply packet as shown in FIG. 11B, and sends it to the radio terminal 33₁.

That is, the GW server 41_{A} assembles a radio packet containing a radio header including (a) the callsign W$1YY of the local repeater 31₁ as the callsign of the repeater of the destination side, (b) the callsign W$1TT of the local repeater 31₂ in the zone to which the GW server 41_{A} belongs as the callsign of the repeater of the departure side, (c) the callsign W$1QQA of the radio terminal 33₁ as the callsign of the companion station, and (d) the callsign W$1TTG of the GW server 41_{A} as the callsign of the own station, and containing the local IP address of the IP device 34₄ as the data of a LAN packet, and sends the produced radio packet to the local repeater 31₂.

The local repeater 31₂ sends the received radio packet to the back bone BB via the back bone repeater 32 in accordance with the callsign of the repeater of the destination side included in the radio header. This radio packet is transmitted through the back bone BB to reach the local repeater 31₁ in accordance with the callsign of the repeater of the destination side, and the local repeater 31₁ transmits the received radio packet in the amateur band.

The radio terminal 33₁ removes the radio header from the received packet, and provides the remaining LAN packet to the IP device 34 which has required the found-out IP address.

(2) Next, an operation for sending data from the IP device 34₁ connected to the radio terminal 33₁ in Area 1 to the IP device 34₄ connected to the radio terminal 33₄ in Area 4 via the Internet IN will be explained.

The IP device 34₁ (for example, a personal computer) designates the local IP address of the IP device 34₄ in Area 4 as the address of the companion side and the local IP address of the IP device 34₁ itself as the address of the own side, and assembles a LAN packet including the data to be sent.

The user inputs (a) the callsign W$1TTG of the GW server 41_{A} as the callsign of the repeater of the destination side, (b) the callsign W$1YY of the local repeater 31₁ in Area 1 as the callsign of the repeater of the departure side, (c) the callsign W$1WWB of the radio terminal 33₄ as the callsign of the companion station, and (d) the callsign W$1QQA of the radio terminal 33₁ as the callsign of the own station to the radio terminal 33₁. Other kind of information may be input and the radio terminal 33₁ may obtain the above-listed information by appropriately converting the input information. Finally, the user inputs an instruction for performing data communication.

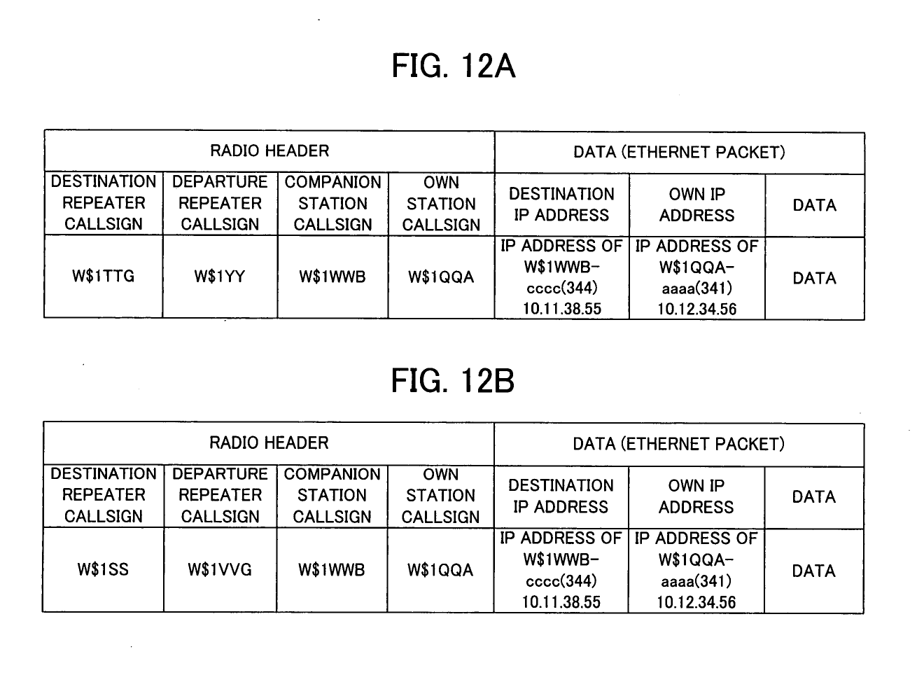

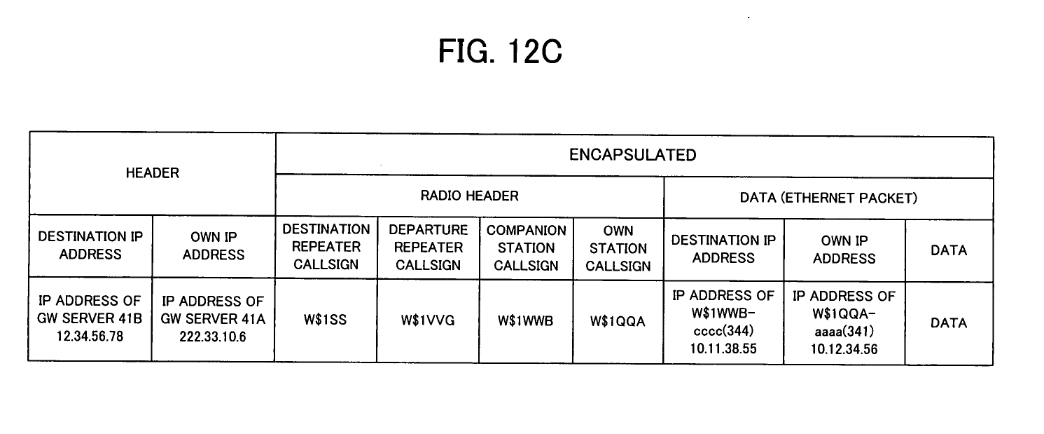

In response to this instruction, the radio terminal 33₁ assembles a radio packet as shown in FIG. 12A containing a radio header and sends the produced radio packet to the local repeater 31₁.

That is, the radio terminal 33₁ assembles a radio packet containing a radio header including (a) the callsign W$1TTG of the GW server 41_{A} as the callsign of the repeater of the destination side, (b) the callsign W$1YY of the local repeater 31₁ in Area 1 as the callsign of the repeater of the departure side, (c) the callsign W$1WWB of the radio terminal 33₄ in Area 4 as the callsign of the companion station, and (d) the callsign W$1QQA of the radio terminal 33₁ as the callsign of the own station, and also containing a LAN packet including the local IP address of the IP device 34₄ as the IP address of the companion side, the local IP address of the IP device 34₁ as the IP address of the own side, and the data to be sent, and sends the produced radio packet to the local repeater 31₁.

The local repeater 31₁ sends the received radio packet to the back bone BB via the back bone repeater 32 in accordance with the callsign of the repeater of the destination side included in the radio header.

The radio packet is transmitted through the back bone BB to reach the zone repeater 31₂ in accordance with the callsign (the six higher-order characters) of the repeater of the destination side, and the zone repeater 31₂ passes the received radio packet to the GW server 41_{A} in accordance with the last character of the callsign.

The GW server 41_{A} encapsulates the received packet to transform it into the VPN format, on the determination that the IP address of the companion side included in the LAN packet is a local IP address that does not exist in the zone A.

At this time, the GW server 41_{A} changes the callsign of the repeater of the destination side to the callsign W$1SS of the local repeater 31₄ in Area 4 which is the final destination, and rewrites the callsign of the repeater of the departure side to the callsign W$1VVG of the GW server 41_{B} in the zone B, as shown in FIG. 12B.

Then, the GW server 41_{A} affixes a radio header including the global IP address of the GW server 41_{B} as the IP address of the companion side and the global IP address of the GW server 41_{A} as the IP address of the own side to the radio packet shown in FIG. 12B to produce a communication packet shown in FIG. 12C, and sends the produced communication packet to the Internet IN.

The communication packet is transmitted through the Internet IN and received by the GW server 41_{B} in the zone B.

The GW server 41_{B} removes the radio header to reproduce the encapsulated packet shown in FIG. 12B, and outputs the reproduced packet to the back bone BB in the zone B via the zone repeater 31₃. This radio packet is transmitted through the back bone BB to reach the local repeater 31₄ and sent from the local repeater 31₄ by radio and received by the radio terminal 33₄.

The radio terminal 33₄ removes the radio header from the received radio packet and provides the remaining packet to the device “aaaa” 34₄, which is the IP device 34 designated by the local IP address of the companion side.

In this manner, data communication via the Internet becomes possible between the IP devices 34₁ and 34₄.

When the radio terminal 33₄ sends a reply to the radio terminal 33₁ in the same manner, the radio terminal 33₄ needs only to simply interchange the callsign of the companion side and the callsign of the own side in the radio header in the received radio packet. That is, the radio terminal 33₄ designates the callsign W$1VVG of the GW server 41_{B} as the callsign of the repeater of the destination side, the callsign W$1SS of the local repeater 31₄ as the callsign of the repeater of the departure side, the callsign W$1QQA of the radio terminal 31₁ as the callsign of the companion station, and the callsign W$1WWB of the radio terminal 33₄ as the callsign of the own station.

(3) Next, an operation for sending data from the IP device 34₁ in Area 1 to the IP device 34₂ connected to the radio terminal 33₂ in Area 2 in the same zone A will be explained.

The IP device 34₁ (for example, a personal computer) designates the local IP address of the IP device “eeee” 34₂ as the address of the companion side and the local IP address of the IP device 34₁ as the address of the own side, and assembles a LAN packet including the data to be sent. The IP device 34₁ obtains the local IP address of the IP device “eeee” 34₂ by inquiring of the GW server 41_{A} in the manner described above, if necessary.

The user inputs (a) the callsign W$1TT of the local repeater 31₂ as the callsign of the repeater of the destination side, (b) the callsign W$1YY of the local repeater 31₁ as the callsign of the repeater of the departure side, (c) the callsign W$1JSC of the radio terminal 33₂ as the callsign of the companion station, and (d) the callsign W$1QQA of the radio terminal 33₁ as the callsign of the own station.

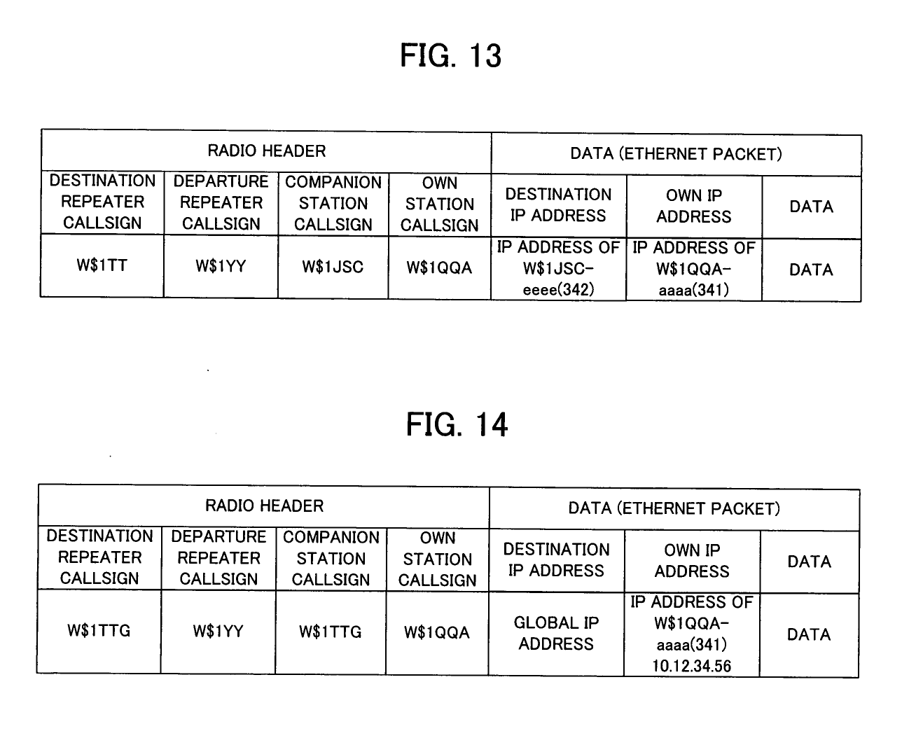

In response to this input, the radio terminal 33₁ assembles a radio packet shown in FIG. 13 including a radio header, and sends the produced radio packet to the local repeater 31₁. The local repeater 31₁ sends the received radio packet to the back bone BB via the back bone repeater 32 in accordance with the callsign of the repeater of the destination side included in the radio header. The radio packet is transmitted through the back bone BB and reaches the local repeater 31₂ in accordance with the callsign of the repeater of the destination side. The local repeater 31₂ determines to acquire this radio packet in accordance with the callsign of the repeater of the destination side, and sends the acquired packet by radio. The radio terminal 33₂ receives this radio packet because the callsign of the companion station included in the radio header of this packet sent by radio is the callsign of the radio terminal 33₂ itself, removes the radio packet from the received radio packet and provides the remaining packet to the IP device 34₂ designated by the included local IP address. Data communication inside the zone network 11 becomes possible in this manner.

(4) An operation for gaining access from the IP device 34₁ connected to the radio terminal 33₁ in Area 1 to a URL existing outside the intranet will be explained.

The IP device 34₁ (for example, a personal computer) designates an arbitrary global IP address as the address of the companion side and the local IP address of the IP deice 34₁ as the address of the own side, and assembles a LAN packet including the data to be sent. The IP device 34₁ obtains the global IP address by making an inquiry to the DNS server 411 if necessary.

The user inputs (a) the callsign W$1TTG of the GW server 41_{A} as the callsign of the repeater of the destination side, (b) the callsign W$1YY of the local repeater 31₁ as the callsign of the repeater of the departure side, (c) the callsign W$1TTG of the GW server 41_{A} as the callsign of the companion station, and (d) the callsign W$1QQA of the radio terminal 33₁ as the callsign of the own station. Other information may be input and the radio terminal 33₁ may obtain the above-listed information by appropriately converting the input information. Finally, the user inputs an instruction for sending data to the IP address of the companion side.

In response to this instruction, the radio terminal 33₁ assembles a radio packet shown in FIG. 14 including a radio header, and sends the produced radio packet to the local repeater 31₁. The local repeater 31₁ sends this radio packet to the back bone BB via the back bone repeater 32 in accordance with the callsign of the repeater of the destination side included in the radio header. The radio packet is transmitted through the back bone BB to reach the zone repeater 31₂ in accordance with the callsign (the six higher-order characters) of the repeater of the destination side, and the zone repeater 31₂ passes the received radio packet to the GW server 41_{A} in accordance with the last character of the callsign of the repeater of the destination side. Based on the determination that the IP address of the companion side included in the LAN packet is a global IP address, the GW server 41_{A} removes the radio header from the received radio packet to convert it into an Internet format and outputs the packet to the Internet IN. Data communication between the IP device 34₁ and an arbitrary device on the Internet IN becomes possible in this manner.

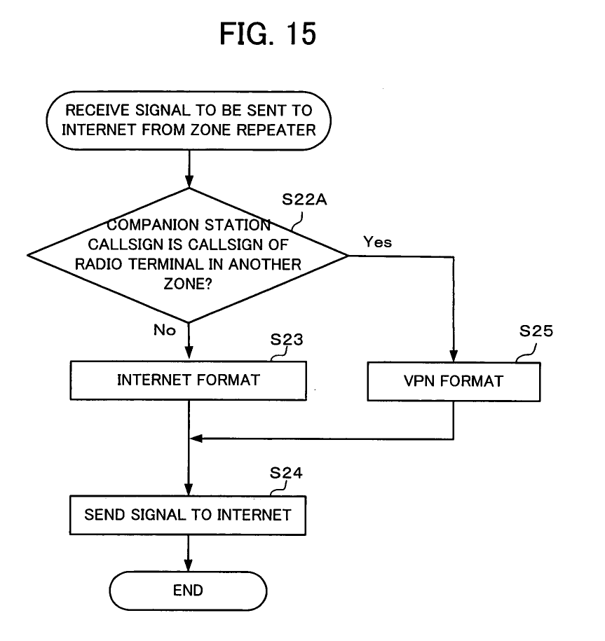

In the above explanation, when the GW server 41 receives a packet from the zone repeater 31, it determines whether the destination of the packet is within or outside the intranet based on the IP address of the destination included in the LAN packet, as shown in FIG. 9. The manner of determining the destination is not limited to this. For example, the destination of a packet can be determined based on the callsign of the companion side which is included in the radio header. For example, as shown in FIG. 15, the GW server 41 may determine whether the callsign of the companion station included in the received packet is of a radio terminal 33 in another zone network 11 by determining whether the callsign is registered in the IP managing table or not (step S22A), and the GW server 41 may encapsulate the packet to transform it into the VPN format (step S25) if the callsign is of a radio terminal 33 in another zone network 11, or may transform it into an Internet format (step S23) if not.

Apart from the above, the manner of determining the companion side or a transmission route is arbitrary.

In the above-described configuration, there may arise a need of expanding the IP address range in the whole intranet or expanding the local IP address range in each area network 21 or zone network 11, because an area network 21 or a zone network 11 is newly built. In this case, it is necessary to expand the local IP address range while maintaining the consistency that runs through the whole intranet. For this purpose, a special managing server for managing the whole intranet may be installed, which however would increase the amount of hardware.

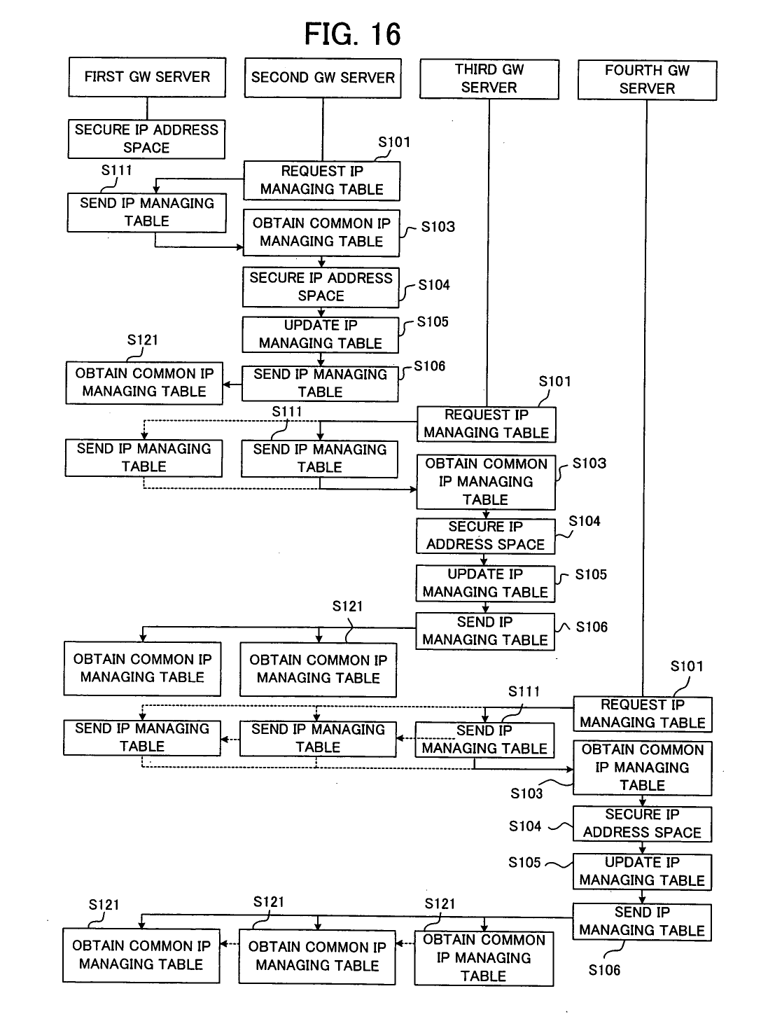

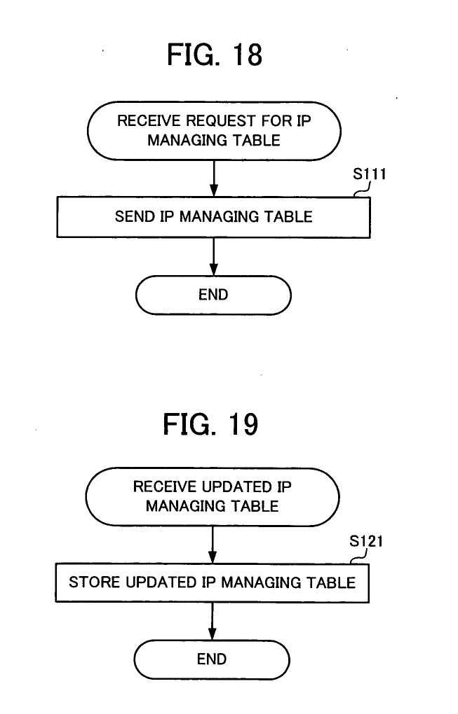

Hence, according to the present embodiment, the consistency is secured in a manner shown in FIG. 16 to FIG. 19.

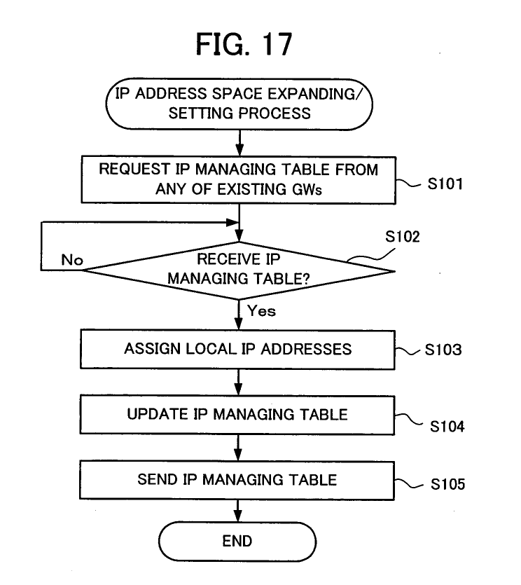

FIG. 16 shows the whole of the process for updating the IP managing table when GW servers are sequentially added. FIG. 17 to FIG. 19 show the individual operation of each GW server 41.

First, assume a case where one or a plurality of GW servers 41 are connected to the Internet IN.

Here, in a case where a new zone network 11 is to be built, the IP managing server 411 of the GW server 41 in the new zone network 11 sends a command to any of the existing GW servers 41 to request it to provide the IP managing table (step S101), and waits for a response (step S102). The GW server 41, which receives this inquiry, sends the IP managing table retained therein to the requesting GW server 41 (step S111).

The IP managing server 411 of the GW server 41 of the new zone network 11 receives the provided IP managing table and saves it in the auxiliary storage unit 423 (step S103), and secures the necessary number (designated by the user) of local IP addresses while avoiding conflicts with the local IP addresses registered in the provided IP managing table (step S104). The user builds up a network by assigning the secured addresses to the user's respective IP devices, and adds information on the built-up network to the IP managing table (step S105).

When the update of the IP managing table is completed, the IP managing server 411 requests the system administrator to give an authorization to send IP managing table. The IP managing server 411 sends the updated IP managing table to all the other GW servers 411, when the system administrator gives a permission to send it (step S106). Each GW server 41 receives the updated IP managing table and overwrites it on the existing IP managing table (step S121).

With this configuration, it is possible to secure local IP addresses with no inconsistency, even without preparing a system for managing the whole. It is effective to define the rule by which local IP addresses are secured in the IP managing table, so that a new GW server which receives the IP managing table from an existing GW server may secure IP addresses by this rule.

The present invention is not limited to the above-described embodiment, but can be modified and applied in various manners.

The system configuration, the hardware configuration, the operations, etc. illustrated in the above-described embodiment may be arbitrarily changed as long as substantially the same function can be realized by the changed configurations, etc.

A program for controlling a computer to execute any of the above-described operations may be distributed by means of a recording medium, or may be distributed via a network. This computer program is recorded on a recording medium of a computer and installed in the computer.

### INDUSTRIAL APPLICABILITY

According to the above-described configuration, communication between internal networks becomes possible via the Internet. Further, management of identification information becomes easy.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A network system comprising a plurality of internal networks and radio terminals belonging to each of said internal networks, wherein:
said radio terminals perform communication with radio terminals belonging to another internal network;
each of said internal networks comprises communication networks, a gateway for connecting said communication networks to Internet, and said radio terminals connected to said communication networks;
each of said radio terminals has identification information that is defined unique in all of said internal networks;
said gateway has a global IP address on the Internet, and includes an address managing table which stores each radio terminal belonging to said internal network in association with the global IP address of said gateway of said internal network to which said radio terminal belongs;
said radio terminals perform communication via said communication network by specifying each other by said identification information;
when said gateway receives information in which identification information of a radio terminal in another internal network is designated as a destination address from a radio terminal via said communication network, it refers to the address managing table to find the global IP address assigned to said gateway of said internal network to which said radio terminal having said destination address belongs, and sends the received information to the Internet to reach the found global IP address; and
when said gateway receives information in which the global IP address of said gateway itself is designated as a destination address from the Internet, it sends the received information via said communication network to a radio terminal which is specified by identification information included in the received information.

2. The network system according to claim 1, wherein:
when said gateway receives information in which identification information of a radio terminal in another internal network is designated as a destination address from a radio terminal via said communication network, it encapsulates the received information, affixes to the encapsulated information, a header including the global IP address assigned to the gateway of the internal network to which said radio terminal having the destination address belongs to the encapsulated information, and sends the information to the Internet; and
when said gateway receives information in which the global IP address of said gateway itself is designated as a destination address, it removes a header affixed to the received information to reproduce encapsulated information, and sends the reproduced information via said communication network to a radio terminal which is specified by identification information included in the reproduced information.

3. The network system according to claim 1, wherein:
each radio terminal has an assigned callsign which serves as the identification information;
said communication network comprises a repeater which has an assigned callsign and performs radio communication with a predetermined radio terminal by using the callsign, and a network for connecting a plurality of repeaters to said gateway;
said radio terminal sends or receives information containing a radio header including the callsigns of a repeater and radio terminal to which the information is addressed, and the callsigns of a repeater and radio terminal from which the information is sent; and
said repeater sends or receives information containing a header to and from a repeater which is included in the radio header as a repeater to which the information is addressed or as a repeater from which the information is sent.

4. The network system according to claim 2, wherein:
each radio terminal has an assigned callsign which serves as the identification information;
said communication network comprises a repeater which has an assigned callsign and performs radio communication with a predetermined radio terminal by using the callsign, and a network for connecting a plurality of repeaters to said gateway;
said radio terminal sends or receives information containing a radio header including the callsigns of a repeater and radio terminal to which the information is addressed, and the callsigns of a repeater and radio terminal from which the information is sent; and
said repeater sends or receives information containing a header to and from a repeater which is included in the radio header as a repeater to which the information is addressed or as a repeater from which the information is sent.

5. The network system according to claim 3, wherein:
each radio terminal comprise data processing devices which each have an assigned local IP address;
said radio terminal sends data containing a local IP address of a sender of the data and a local IP address of a receiver of the data, by affixing the radio header to the data; and
said radio terminal receives data to which the radio header is affixed, removes the radio header, and provides the received data to a data processing device which is specified by the local IP address of the receiver contained in the received data.

6. The network system according to claim 4,
each radio terminal comprise data processing devices which each have an assigned local IP address;
said radio terminal sends data containing a local IP address of a sender of the data and a local IP address of a receiver of the data, by affixing the radio header to the data; and
said radio terminal receives data to which the radio header is affixed, removes the radio header, and provides the received data to a data processing device which is specified by the local IP address of the receiver contained in the received data.

7. The network system according to claim 1, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

8. The network system according to claim 2, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

9. The network system according to claim 3, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

10. The network system according to claim 4, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

11. The network system according to claim 5, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

12. The network system according to claim 6, wherein:
a gateway to be newly added in an internal network requires the address managing table from an existing gateway, secures new identification information based on the received address managing table, updates the address managing table based on the secured identification information, and sends the updated address managing table to all the other gateways; and
each gateway sends its own address managing table in response to a request for the address managing table from another gateway, and changes its own existing address managing table to an updated address managing table when it receives the updated address managing table from another gateway.

13. A gateway for connecting an internal network to Internet, in a network system in which a plurality of internal networks are connected to each other via the Internet, and radio terminals belonging to each internal network perform communication with radio terminals in another internal network via the Internet, wherein:
said gateway has a global IP address on the Internet, and includes an address managing table which stores each radio terminal belonging to said internal network in association with the global IP address of said gateway of said internal network to which said radio terminal belongs, and
said gateway comprises:
external sending means for referring to the address managing table when receiving information in which identification information of a radio terminal in an internal network independent from said gateway is designated as a destination address from a radio terminal via a communication network, finding the global IP address assigned to said gateway of said internal network to which said radio terminal specified by the identification information belongs, and sending the received information to the Internet by addressing the received information to the found global IP address; and
internal sending means for, when receiving information in which the global IP address of said gateway itself is designated as a destination address from the Internet, sending the received information to a radio terminal which is specified by identification information included in the received information via said communication network.

14. The gateway according to claim 13, wherein:
the identification information is a callsign;
when said external sending means receives data to which a radio header including a companion station callsign designating a radio terminal in another internal network, a destination repeater callsign, a departure repeater callsign, and a own station callsign designating a radio terminal from which the data is sent is affixed, said external sending means encapsulates the received data, affixes to the encapsulated data a radio header including the global IP address of a gateway to which the data is sent and the global IP address of said gateway itself, and sends the data to the Internet; and
when said internal sending means receives information addressed thereto from the Internet, it removes a radio header from the received information to reproduce data to which a radio header is affixed, and sends the reproduced data to said communication network.

15. The gateway according to claim 13, wherein:
the identification information is a callsign;
when said external sending means receives data to which a radio header including a destination repeater callsign designating said gateway itself, a departure repeater callsign, a companion station callsign, and a own station callsign is affixed, said external sending means
rewrites the destination repeater callsign included in the radio header into a callsign of a repeater with which a radio terminal specified by the companion station callsign included in the radio header performs radio communication, and the departure repeater callsign included in the radio header into a callsign of a gateway to which the received data is to be sent, and
encapsulates the rewritten radio header and the data, affixes a radio header including a global IP address to which the data is to be sent and the global IP address of said gateway itself to the encapsulated data, and sends it to the Internet; and
when said internal sending means receives information addressed to said gateway itself from the Internet, said internal sending means removes a radio header from the received information to reproduce data to which a radio header is affixed, and sends the reproduced data to said communication network.

16. The gateway according to claim 13, wherein:
the address managing table further stores information that associates the callsign of said radio terminal, information for specifying data processing devices which are connected to said radio terminal, and local IP addresses of said data processing devices with one another; and
when said gateway receives an inquiry request containing the callsign of a radio terminal and the information for specifying a data processing device connected to said radio terminal, said gateway finds the local IP address assigned to said data processing device from the address managing table and sends the local IP address to the request sender.

17. The gateway according to claim 14, wherein:
the address managing table further stores information that associates the callsign of said radio terminal, information for specifying data processing devices which are connected to said radio terminal, and local IP addresses of said data processing devices with one another; and
when said gateway receives an inquiry request containing the callsign of a radio terminal and the information for specifying a data processing device connected to said radio terminal, said gateway finds the local IP address assigned to said data processing device from the address managing table and sends the local IP address to the request sender.

18. The gateway according to claim 15, wherein:
the address managing table further stores information that associates the callsign of said radio terminal, information for specifying data processing devices which are connected to said radio terminal, and local IP addresses of said data processing devices with one another; and
when said gateway receives an inquiry request containing the callsign of a radio terminal and the information for specifying a data processing device connected to said radio terminal, said gateway finds the local IP address assigned to said data processing device from the address managing table and sends the local IP address to the request sender.

19. A radio terminal used in a network system in which a plurality of internal networks each comprise radio terminals, a repeater for performing radio communication with said radio terminals, and a gateway connected to said repeater via a communication cable, each of said internal networks is connected to Internet via said gateway, and each of said radio terminals performs communication with said radio terminal belonging to another internal network via said repeater, said gateway, and the Internet, said radio terminal comprising:
radio communication means;
data communication means for sending and receiving data to and from data processing devices;
input means for receiving an input of identification information of a radio terminal to which data is to be sent; and
control means for affixing to data to be sent that is received from a data processing device by said data communication means, a radio header including a callsign of a repeater to which the data is to be sent, a callsign of a repeater from which the data is to be sent, a callsign of a radio terminal to which the data is to be sent, and a callsign of said radio terminal itself from which the data is to be sent based on the information input from said input means, and sending the data via said radio communication means to said repeater from which the data is to be sent, while when receiving data to which a radio header including a callsign of said radio terminal itself as a destination address is affixed from said repeater, removing the radio header from the received data, identifying a data processing device from a destination address included in the received data, and providing the received data to said identified data processing device,
wherein when data is to be sent to a radio terminal in another internal network, said control means designates a callsign of said gateway in said internal network to which said radio terminal itself belongs as the callsign of a repeater to which the data is to be sent, and designates a callsign of said radio terminal to which the data is finally addressed as the callsign of a radio terminal to which the data is to be sent.

20. A computer-readable recording medium storing a program for enabling a computer to realize a function of a gateway for connecting a plurality of internal networks to Internet, in a network system in which said internal networks are connected to each other via the Internet, and radio terminals belonging to each internal network perform communication with radio terminals belonging to another internal network, wherein:
said computer has a global IP address on the Internet, and includes an address managing table which stores each radio terminal in said internal network in association with the global IP address of said gateway of said internal network to which said radio terminal belongs; and
said program controls said computer to function as:
external sending means for referring to the address managing table when receiving information in which identification information of a radio terminal in an internal network independent from said gateway is designated as a destination address from a radio terminal via a communication network, finding the global IP address assigned to said gateway of said internal network to which said radio terminal specified by the identification information belongs, and sending the received information to the Internet by addressing the received information to the found global IP address; and
internal sending means for, when receiving information in which the global IP address of said gateway itself is designated as a destination address from the Internet, sending the received information to a radio terminal which is specified by identification information included in the received information via said communication network.

21. A computer-readable recording medium storing a program for enabling a computer to realize a function of a radio terminal which is used in a network system in which a plurality of internal networks each comprise radio terminals, a repeater for performing radio communication with said radio terminals, and a gateway connected to said repeater via a communication cable, each of said internal networks is connected to Internet via said gateway, and each of said radio terminals performs communication with said radio terminal belonging to another internal network via said repeater, said gateway, and the Internet, said program controlling said computer to function as:
radio communication means;
data communication means for sending and receiving data to and from data processing devices;
input means for receiving an input of identification information of a radio terminal to which data is to be sent; and
control means for affixing to data to be sent that is received from a data processing device by said data communication means, a radio header including a callsign of a repeater to which the data is to be sent, a callsign of a repeater from which the data is to be sent, a callsign of a radio terminal to which the data is to be sent, and a callsign of said radio terminal itself from which the data is to be sent based on the information input from said input means, and sending the data via said radio communication means to said repeater from which the data is to be sent, while when receiving data to which a radio header including a callsign of said radio terminal itself as a destination address is affixed from said repeater, removing the radio header from the received data, identifying a data processing device from a destination address included in the received data, and providing the received data to said identified data processing device,
wherein when data is to be sent to a radio terminal in another internal network, said control means designates a callsign of said gateway in said internal network to which said radio terminal itself belongs as the callsign of a repeater to which the data is to be sent, and designates a callsign of said radio terminal to which the data is finally addressed as the callsign of a radio terminal to which the data is to be sent.
